(19) United States
(12) Patent Application Publication
(10) Pub. No.: US 2006/0222391 A1
(43) Pub. Date: Oct. 5, 2006

(54) Method and apparatus for controlling transfer voltage in image forming device

(75) Inventor: Jeong-jai Choi, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/388,969

(22) Filed: Mar. 27, 2006

(30) Foreign Application Priority Data
Mar. 30, 2005 (KR) 2005-26505

(51) Int. Cl. G03G 15/16

(52) U.S. Cl. 399/66

(57) ABSTRACT

A method of and apparatus for controlling a transfer voltage in an electro-photographic image forming apparatus. A transfer roller resistance between a transfer roller and a photosensitive drum is detected with a constant voltage applied to the transfer roller in a state where the photosensitive drum and the transfer roller form a transfer nip. A paper resistance among the transfer roller, a paper, and the photosensitive drum is detected when the constant voltage is applied to the transfer roller while the paper approaches the transfer nip of the transfer roller. A paper type is determined and a transfer voltage is selectively applied to the transfer roller based on the detected transfer roller and paper resistances. Reference tables are stored in a memory to aid in determining the paper type and the applied transfer voltage.

### CROSS-REFERENCE TO RELATED APPLICATIONS

This application claims the benefit of Korean Application No. 2005-26505, filed on Mar. 30, 2005, in the Korean Intellectual Property Office, the disclosure of which is incorporated herein by reference.

### BACKGROUND OF THE INVENTION

1. Field of the Invention

Aspects of the present invention relate to a method of and an apparatus for controlling a transfer voltage in an image forming apparatus, and more particularly, to a method of and an apparatus for controlling a transfer voltage in an electrophotographic image forming apparatus in which a type of paper is determined using a transfer roller resistance and a paper resistance, and a proper transfer voltage is applied according to a transfer table for the determined type of paper.

2. Description of the Related Art

In general, an image forming apparatus forms an image by charging a surface of a photosensitive medium using a charging device, and radiating light onto the photosensitive medium using a laser scanning unit according to a print signal to form an electrostatic latent image thereon, forming a toner image using toners supplied from developing units, and transferring the toner image onto paper.

The image forming apparatus uses a method of contacting the photosensitive medium with the charging device to charge the surface of the photosensitive medium to a predetermined potential. Using a potential difference between the devices, a toner is attached to the electrostatic latent image formed on the photosensitive medium or the toner image is transferred from the photosensitive medium onto a transfer device or from the transfer device onto paper.

In order to obtain a good quality image, an appropriate transfer voltage must be applied to a transfer roller to transfer the toner image formed on the photosensitive medium onto the paper.

U.S. Pat. No. 5,682,575, entitled “Electrophotographic Recording Apparatus Having Transfer Voltage Control Device,” discloses a method of measuring a resistance of a transfer roller when a top end of paper passes through a transfer roller and supplying a transfer voltage to the transfer roller so that an appropriate voltage is supplied to the transfer roller according to the type of paper. In the method disclosed in U.S. Pat. No. 5,682,575, the resistance of the transfer roller is detected while the paper does not pass between the photosensitive medium and the transfer roller, a high voltage is applied to the transfer roller while a leading end of the paper passes between the photosensitive medium and the transfer roller to detect a combined resistance of the paper, the photosensitive medium, and the transfer roller, the resistance of the transfer roller is compared with the combined resistance, and an appropriate transfer voltage is applied to the transfer roller, thereby controlling the transfer voltage.

However, since this method does not consider environmental changes of the transfer roller resulting from the application of a transfer voltage that varies according to the resistance of paper and any change caused by long term usage, a transfer failure may occur due to the application of an improper transfer voltage or an image may distort due to the application of an overvoltage.

### SUMMARY OF THE INVENTION

Aspects of the present invention provide a method of and an apparatus for controlling a transfer voltage by detecting a transfer roller resistance and a paper resistance, determining the type of a paper using a relationship between a variation in transfer roller resistance and a variation in paper resistance, and applying an appropriate transfer voltage to a transfer roller with reference to a transfer table for each type of paper.

According to an aspect of the present invention, there is provided an apparatus for controlling a transfer voltage in an electrophotographic image forming apparatus using an electric transfer roller, the apparatus comprising: a transfer roller resistance detecting unit detecting a transfer roller resistance between a transfer roller and a photosensitive drum when a constant voltage is applied to the transfer roller in a state where the photosensitive drum and the transfer roller form a transfer nip; a paper resistance detecting unit detecting a paper resistance among the transfer roller, a paper, and the photosensitive drum when the constant voltage is applied to the transfer roller while the paper approaches the transfer nip of the transfer roller; a memory storing a paper resistance recognition table and a transfer table for each type of paper; and a transfer voltage controlling unit determining the type of the paper based on the transfer roller resistance and the paper resistance and outputting a transfer voltage with reference to the transfer table.

The transfer voltage controlling unit may comprise: a paper type determining unit determining the type of the paper using the transfer roller resistance and the paper resistance with reference to the paper resistance recognition table; and a transfer voltage outputting unit outputting the transfer voltage with reference to the transfer table for the determined type of the paper if the type of the paper have been determined, and outputting the transfer voltage with reference to a general transfer table if the type of the paper have not been determined.

According to another aspect of the present invention, there is provided a method of controlling a transfer voltage in an image forming apparatus, the method comprising: applying a constant voltage to a transfer roller in a state where a photosensitive drum and the transfer roller form a transfer nip and detecting a transfer roller resistance between the transfer roller and the photosensitive drum; applying the constant voltage to the transfer roller when paper approaches the transfer nip of the transfer roller and detecting a paper resistance among the transfer roller, the paper, and the photosensitive drum; determining a type of paper from a paper resistance recognition table based on the transfer roller resistance and the paper resistance; and applying the transfer voltage to the transfer roller with reference to the determined type paper and a transfer table to perform a transferring operation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram of an image forming apparatus to which a method of controlling a transfer voltage according to an embodiment of the present invention is applied;

FIG. 2 is a block diagram of an apparatus for controlling a transfer voltage in the image forming apparatus of FIG. 1;

FIG. 3A shows an example of variation in a transfer roller resistance;

FIGS. 3B and 3C illustrate examples of variation in paper resistance;

FIGS. 3D and 3E illustrate examples of a paper resistance recognition table;

FIGS. 3F and 3G illustrate examples of a transfer table; and

FIG. 4 is a flowchart illustrating a method of controlling a transfer voltage in an image forming apparatus according to an embodiment of the present invention.

### DETAILED DESCRIPTION OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

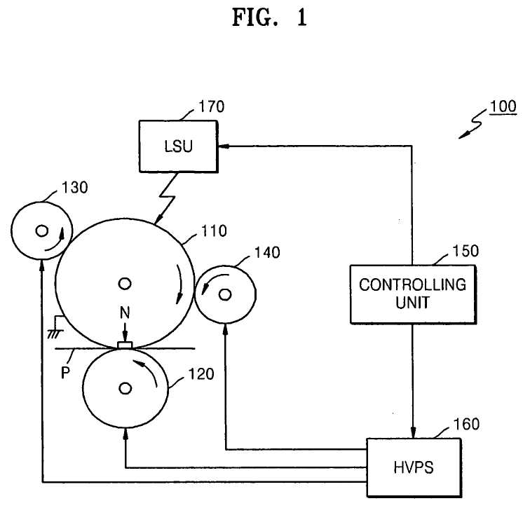

FIG. 1 is a schematic diagram of an image forming apparatus 100 to which a method of controlling a transfer voltage according to an embodiment of the present invention may be applied. The image forming apparatus 100 includes a photosensitive drum 110, a transfer roller 120, a charging roller 130, a developing roller 140, a controlling unit 150, a high voltage power supply unit (HVPS) 160, and a laser scanning unit (LSU) 170.

The HVPS 160 is controlled by the controlling unit 150 and applies a high voltage to the transfer roller 120, the charging roller 130, and the developing unit 140. The charging roller 130, which receives a high negative voltage, charges the photosensitive drum 110 to a constant negative potential. The LSU 170 radiates a laser beam onto a surface of the photosensitive drum 110, causing a potential difference. As a result, an electrostatic latent image is formed on the surface of the photosensitive drum 110. A toner charged with a negative potential is adhered to the electrostatic latent image by the developing roller 140. At a transfer nip N formed as the photosensitive drum 110 and the transfer roller 120 contact, the toner image on the photosensitive drum 110 is transferred to a paper P by the transfer roller 120 which receives a high positive voltage from the HVPS 170. In the image forming apparatus 100, the transfer roller 120 is an electric conductivity type ethylene propylene dimonomer (EPDM) sponge having a resistance between 60 MΩ and 260 MΩ.

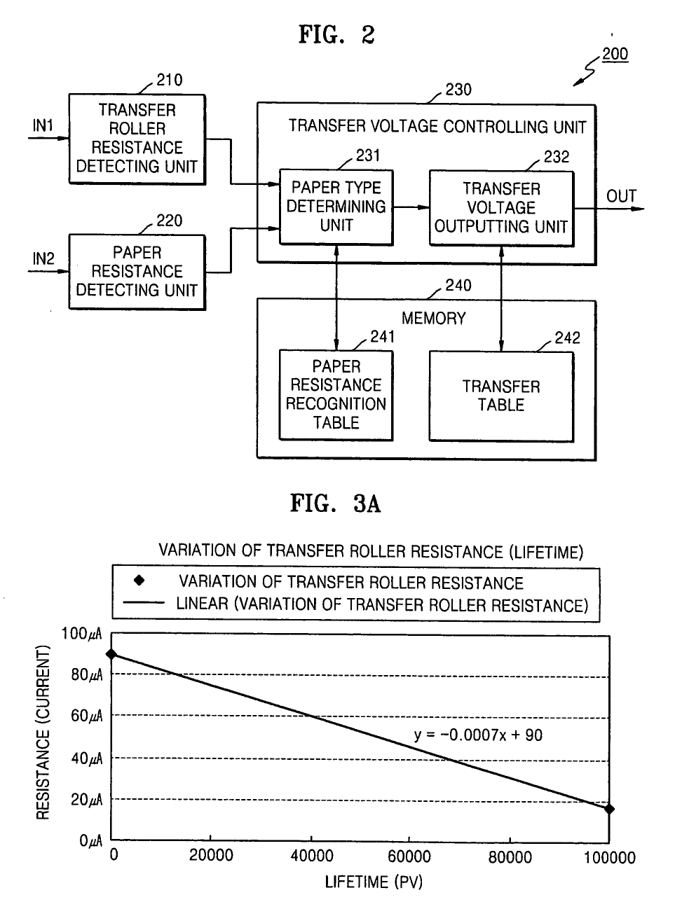

FIG. 2 is a block diagram of an apparatus 200 for controlling a transfer voltage in an image forming apparatus according to an embodiment of the present invention. The apparatus 200 includes a transfer roller resistance detecting unit 210, a paper resistance detecting unit 220, a transfer voltage controlling unit 230, and a memory 240.

Referring to FIGS. 1 and 2, when a constant high voltage, for example, +1800V, is applied to the transfer roller 120 in a state where the photosensitive drum 110 and the transfer roller 120 form the transfer nip (N), the transfer roller resistance detecting unit 210 receives as a feedback a signal IN1 representing an amount of current flowing in the transfer roller 120 and detects a combined resistance (hereinafter, referred to as a transfer roller resistance) of the transfer roller 120 and the photosensitive drum 110.

When printing paper is fed and approaches the transfer nip N, the paper resistance detecting unit 220 receives a signal IN2 representing the amount of current flowing in the transfer roller 120 and detects a combined resistance of the transfer roller 120, the paper P, and the photosensitive drum 110 (hereinafter, referred to as a paper resistance). At this time, the high voltage applied to the transfer roller 120 is adjusted to be equal to the voltage applied to the transfer roller 120 when detecting the transfer roller resistance. This is for reducing a deviation caused by overshoot, etc., which would occur when the voltage applied to obtain a paper resistance and the voltage applied to obtain a transfer roller resistance are different.

The transfer voltage controlling unit 230 determines the type of paper using a relationship between the transfer roller resistance and the paper resistance and outputs a transfer voltage OUT corresponding to the transfer roller resistance with reference to a transfer table for the determined type of paper. The transfer voltage controlling unit 230 includes a paper type determining unit 231 and a transfer voltage outputting unit 232.

A paper resistance recognition table 241 which is used to determine the type of paper and a transfer table 242 which provides a transfer voltage corresponding to the transfer roller resistance are stored in the memory 240.

The paper determining unit 231 determines the type of paper from the paper resistance recognition table 241 based on the transfer roller resistance and the paper resistance.

The transfer voltage outputting unit 232 outputs the transfer voltage with reference to the transfer table 242. If the type of paper is determined in the paper type determining unit 231, the transfer voltage outputting unit 232 outputs a transfer voltage corresponding to the transfer roller resistance with reference to the transfer table for the determined type of paper. If the type of the paper is not determined by the paper type determining unit 231, the transfer voltage outputting unit 232 outputs a transfer voltage with reference to a general transfer table.

The paper resistance recognition table 241 is calculated using a variation in transfer roller resistance due to environment conditions and a life span of the transfer roller and the variation in paper resistance

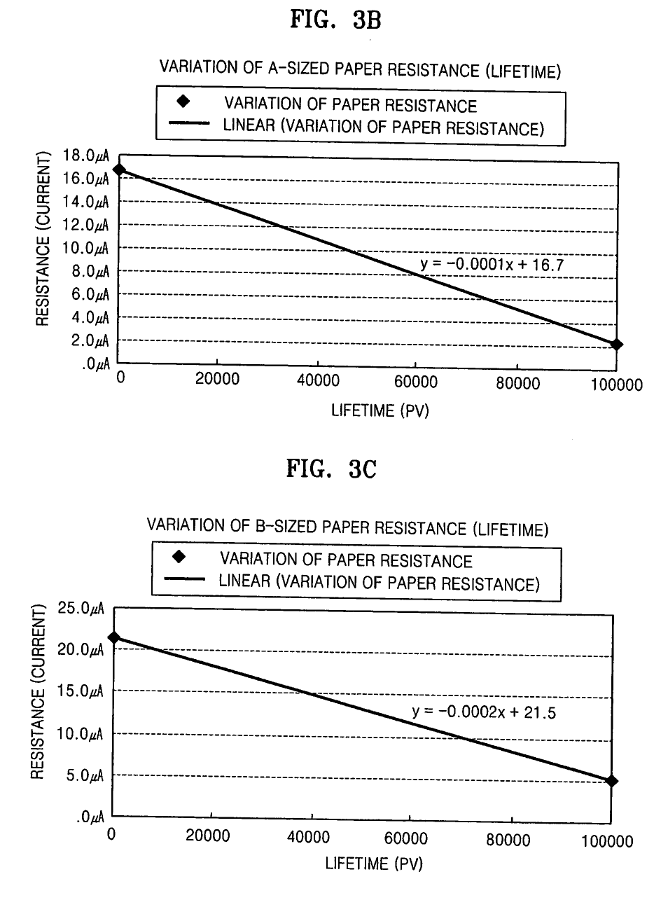

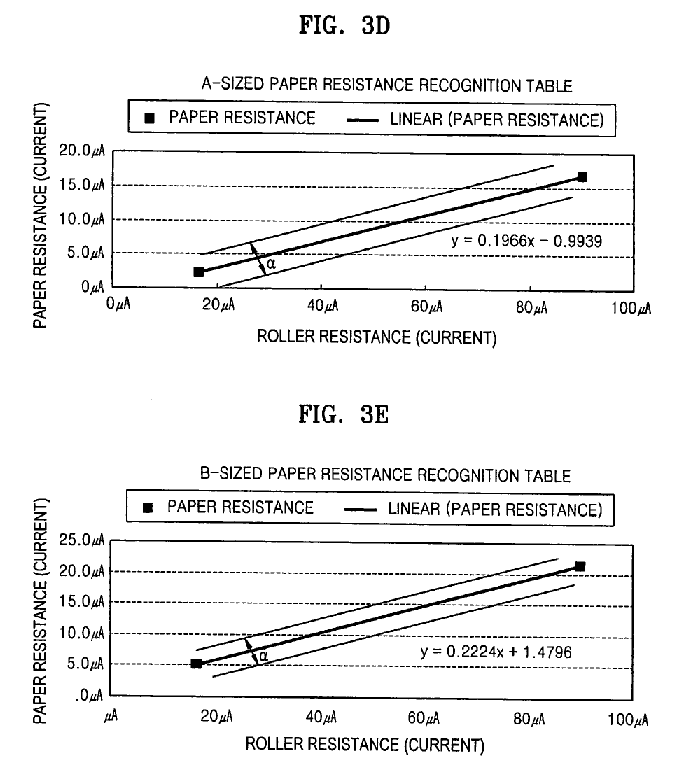

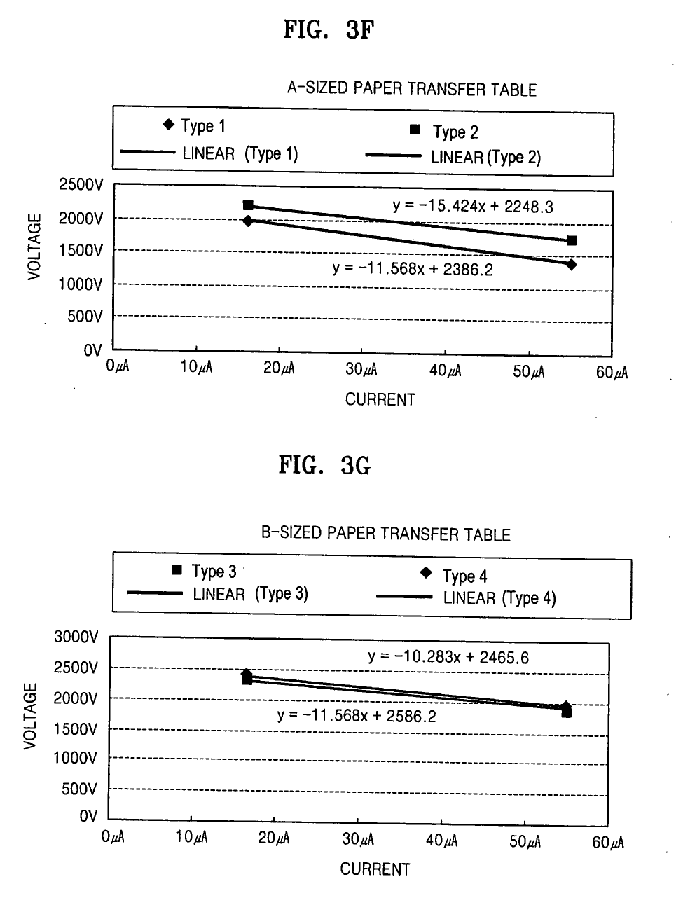

FIG. 3A is a graph illustrating the variation in transfer roller resistance and FIGS. 3B and 3C are graphs illustrating variations in paper resistance obtained by experiments. The variation in transfer roller resistance of FIG. 3A and the variations in paper resistance of FIGS. 3B and 3C with respect to the life span of the developing unit were experimentally obtained. The values of transfer roller resistance and paper resistance shown in FIGS. 3A through 3C are given in units of current. Since current is generally inversely related to electrical resistance, lower current values of current shown in FIGS. 3A-3C represent higher resistance values and higher current values represent lower resistance values. Thus, the transfer roller resistance increases during the life span (LIFETIME (PV) of the transfer roller.

The result of calculating a paper resistance recognition table for A-sized paper based on the results in FIGS. 3A and 3B is shown in FIG. 3D, and the result of calculating a paper resistance recognition table for B-sized paper based on the results in FIGS. 3A and 3C is shown in FIG. 3E. In FIGS. 3D and 3E, the relationship between the transfer roller resistance and the paper resistance is linear.

The relationship between the type of paper and the paper resistance recognition table 241 may be expressed by equation (1):
Yi=eX+ƒ±α (1)
where Yi denotes the paper resistance (current), X denotes the transfer roller resistance (current), α denotes an error range, and e and f denote constants obtained from the variation in transfer roller resistance and the variation in paper resistance.

When the paper type determining unit 231 determines the type of paper using the transfer roller resistance and the paper resistance, the transfer roller resistance and the paper resistance may not accurately match values in the sheet resistance recognition table 241. However, if the transfer roller resistance and the paper resistance fall within a range α of an entry in the paper resistance recognition table for a type of paper, the paper is regarded as the type of paper corresponding to the entry. If the transfer roller resistance and the paper resistance do not lie in a range α of an entry in the paper resistance recognition table 241 for a type of paper, the paper type determining unit 231 does not determine the type of paper.

A transfer voltage representing a good printing state for each type of paper is experimentally obtained and stored in the transfer table 242. FIGS. 3F and 3G are graphs illustrating a transfer table representing the transfer voltage corresponding to a transfer roller resistance for paper types 1, 2, 3 and 4. The paper types are identified more specifically in Table 1 below with reference to commercially available paper.

TABLE 1

| Paper Type | Identification |
|---|---|
| 1 | hoopoe (sim) |
| 2 | hoopoe (Dup) |
| 3 | Sanyi7, 80 (sim) |
| 4 | Sanyi7, 80 (Dup) |

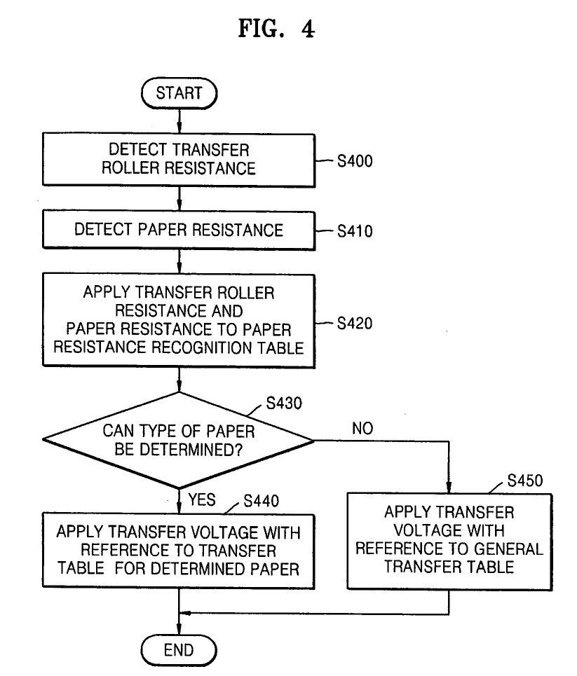

FIG. 4 is a flowchart of a method of controlling a transfer voltage in an image forming apparatus according to an embodiment of the present invention.

Referring to FIGS. 1, 2, and 4, in operation S400, the HVPS 160 applies a constant voltage to the transfer roller 120 in a state where the photosensitive drum 110 and the transfer roller 120 form the transfer nip N, and the transfer roller resistance detecting unit 210 detects the transfer roller resistance as the combined resistance of the transfer roller 20 and the photosensitive drum 110.

In operation S410, the HVPS 160 applies a voltage to the transfer roller 160 that is equal to the voltage applied when detecting the transfer roller resistance while a paper P approaches the transfer nip N, and the paper resistance detecting unit 220 detects the paper resistance as the combined resistance of the transfer roller 120, the paper P, and the photosensitive drum 110.

In operation S420, the transfer roller resistance and the paper resistance are applied to the paper resistance recognition table 241 to determine a type of the paper P.

In operation S430, it is determined whether the type of paper can be determined. If the type of paper can be determined, a transfer voltage corresponding to the transfer roller resistance is applied to the transfer roller 120 with reference to the transfer table 242 for the determined type of paper, in operation S440. Otherwise, another transfer voltage corresponding to the transfer roller resistance is applied to the transfer roller 120 with reference to a general transfer table.

According to aspects of the present invention, a proper transfer voltage is applied in consideration of environmental changes of the transfer roller and any change caused by long term usage, so that it is possible to prevent a transfer failure caused by the application of an improper transfer voltage or an image distortion caused by the application of an overvoltage.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An apparatus for controlling a transfer voltage in an electrophotographic image forming apparatus using an electric transfer roller and a photosensitive drum, the apparatus comprising:
a transfer roller resistance detecting unit detecting a transfer roller resistance between the transfer roller and the photosensitive drum when a constant voltage is applied to the transfer roller in a state where the photosensitive drum and the transfer roller form a transfer nip;
a paper resistance detecting unit detecting a paper resistance among the transfer roller, a paper, and the photosensitive drum when the constant voltage is applied to the transfer roller while the paper approaches the transfer nip of the transfer roller;
a memory storing a paper resistance recognition table and a transfer table for at least one type of paper; and
a transfer voltage controlling unit determining the type of the paper based on the transfer roller resistance and the paper resistance and outputting the transfer voltage with reference to the transfer table.

2. The apparatus of claim 1, wherein the transfer voltage controlling unit comprises:
a paper type determining unit determining the type of the paper using the transfer roller resistance and the paper resistance with reference to the paper resistance recognition table; and
a transfer voltage outputting unit outputting the transfer voltage with reference to the transfer table for the determined type of the paper if the type of the paper has been determined, and outputting a different transfer voltage with reference to a general transfer table if the type of the paper has not been determined.

3. The apparatus of claim 1, wherein:
the paper resistance recognition table and the transfer table include information about a plurality of paper types and
a relationship between each type of paper and the paper resistance recognition table is given by: Yi=eX+ƒ±α
where Yi denotes the paper resistance, X denotes the transfer roller resistance, α denotes an error range, and e and f denote constants obtained from a variation in transfer roller resistance and a variation in paper resistance.

4. The apparatus of claim 1, wherein the transfer table comprises a transfer voltage corresponding to the transfer roller resistance for each type of paper.

5. A method of controlling a transfer voltage in an image forming apparatus, the method comprising:
applying a constant voltage to a transfer roller in a state where a photosensitive drum and the transfer roller form a transfer nip and detecting a transfer roller resistance between the transfer roller and the photosensitive drum;
applying the constant voltage to the transfer roller when paper approaches the transfer nip of the transfer roller and detecting a paper resistance among the transfer roller, the paper, and the photosensitive drum;
determining a type of paper based on the transfer roller resistance and the paper resistance; and
applying the transfer voltage to the transfer roller to perform a transferring operation based on the determined type paper.

6. The method of claim 5, wherein the method further comprises:
determining the type of the paper with reference to a paper resistance recognition table, and
applying the transfer voltage with reference to a transfer table.

7. The method of claim 6, wherein the applying of the transfer voltage comprises:
applying the transfer voltage with reference to the transfer table for the determined type of paper, if the type of paper has been determined, and
applying another transfer voltage with reference to a general transfer table, if the type of paper has not been determined.

8. A method of controlling a transfer voltage applied to a transfer roller in an image forming apparatus having a photosensitive drum, the method comprising:
measuring a first current flowing between the transfer roller and the photosensitive drum in response to a predetermined voltage applied to the transfer roller prior to entry of a printing paper into a nip between the transfer roller and the photosensitive drum;
applying a transfer voltage to the transfer roller based on the measured first current and a paper type.

9. The method of claim 8, further comprising:
measuring a second current between the transfer roller and the photosensitive drum in response to the predetermined voltage applied to the transfer roller during entry of the printing paper into the nip,
determining the paper type based on the measured first and second currents.

10. The method of claim 8, further comprising:
decreasing the transfer voltage as a value of the measured first current increases.

11. A method of controlling a transfer voltage applied to a transfer roller in an image forming apparatus having a photosensitive drum, the method comprising:
determining an expected current flow between the transfer roller and the photosensitive drum in response to a predetermined voltage applied to the transfer roller prior to entry of a printing paper into a nip between the transfer roller and the photosensitive drum, wherein the expected current flow is based on an environmental condition in which the image forming apparatus is operating or an expected life cycle of the transfer roller;
forming a transfer table including entries correlating the transfer voltage, a paper type, a plurality of the expected current flows, and corresponding environmental conditions or the transfer voltage, the paper type, the plurality of expected current flows and predetermined intervals along the expected lifecycle of the transfer roller;
determining an actual current flow between the transfer roller and the photosensitive drum in response to the predetermined voltage applied to the transfer roller prior to the entry of the printing paper into the nip between the transfer roller and the photosensitive drum; and
selecting the transfer voltage to be applied based on an entry in the transfer table correlating the expected current flow and the paper type and the actual current flow and the paper type.
